(19) United States
(12) Patent Application Publication
(10) Pub. No.: US 2015/0351042 A1
(43) Pub. Date: Dec. 3, 2015

(54) System And Method For Improved Transport and Analysis Of Digital Rf Signals In A Radio Network

(71) Applicant: Colby Harper, Seattle, WA (US)

(72) Inventor: Colby Harper, Seattle, WA (US)

(21) Appl. No.: 14/294,147

(22) Filed: Jun. 3, 2014

(51) Int. Cl. H04W 52/18; H04W 24/08

(52) U.S. Cl. CPC H04W 52/18; H04W 24/08

(57) ABSTRACT

A system and method for improved transport and analysis of digital rf signals in a radio network for improving transport, analysis, and management of digital RF signals in a Radio Network. The system and method for improved transport and analysis of digital rf signals in a radio network generally includes a base station digital RF fronthaul software-defined network and RF analysis control plane unit, IQ symbol virtual switch forwarding plane unit(s), Remote radio equipment/antenna unit(s), RF analysis plane unit(s), baseband processing pool, radio parameter configuration process.

This application claims priority of Provisional Application No. 61/830,144 filed on Jun. 2 of the year 2013.

### BACKGROUND OF THE INVENTION

The present invention relates generally to rf network and analysis w/ rf signature integrations and more specifically it relates to a system and method for improved transport and analysis of digital rf signals in a radio network for improving transport, analysis, and management of digital RF signals in a Radio Network.

### BACKGROUND

### Description of Prior Art

Current solutions for transport of I and Q symbol streams from sensors, such as communications antennas, are limited in that while they may provide network transport of the streams to baseband processing nodes for communications and analysis, they do not provide a switching forwarding plane which is both virtualized and integrated with an rf signature based analysis and control plane that provides signature-based traffic and payload analysis and response. Without this, prioritization, Quality of Service, and policy-based RF power control benefits such as those afforded by my invention cannot be efficiently or effectively provided.

### BRIEF SUMMARY OF THE INVENTION

The invention generally relates to a rf network and analysis w/ rf signature integration which includes a base station digital RF fronthaul software-defined network and RF analysis control plane unit, IQ symbol virtual switch forwarding plane unit(s), Remote radio equipment/antenna unit(s), RF analysis plane unit(s), baseband processing pool, radio parameter configuration process.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a system and method for improved transport and analysis of digital rf signals in a radio network for improving transport, analysis, and management of digital RF signals in a Radio Network.

Another object is to provide a System And Method For Improved Transport and Analysis Of Digital Rf Signals In A Radio Network that provides logically centralized and fully flexible software programmable control of IQ symbol forwarding plane switches of input sources and output sinks via both configuration commands and forwarding command rulesets.

Another object is to provide a System And Method For Improved Transport and Analysis Of Digital Rf Signals In A Radio Network that provides logically centralized and fully flexible software programmable control of RF analysis plane integrated and coordinated with the IQ symbol forwarding plane forwarding function via both configuration commands and instrument trigger command rulesets.

Another object is to provide a System And Method For Improved Transport and Analysis Of Digital Rf Signals In A Radio Network that enables sending of real-time copies of all or a subset of the Radio Equipment's Digital RF IQ Symbols simultaneously to one or more virtual or real egress ports terminating in at least one baseband processing pool and at least one RF analysis unit for centralized baseband processing and advanced analysis, troubleshooting, optimization, and treatment of the RF signals.

Another object is to provide a System And Method For Improved Transport and Analysis Of Digital Rf Signals In A Radio Network that determines which IQ symbol subset and virtual or real egress port or ports based on classification and marking policy rules specified in the software-defined network and RF analysis control plane unit external to the at least one switch unit and RF analysis unit, where the global master copy of those match/action policy rules reside in the logically centralized and integrated global RF signature library and forwarding information base data structure of the central control plane unit.

Another object is to provide a System And Method For Improved Transport and Analysis Of Digital Rf Signals In A Radio Network that operates as high-performance virtualized software running on commodity general purpose computer servers.

Another object is to provide a System And Method For Improved Transport and Analysis Of Digital Rf Signals In A Radio Network that enables error correction of the analog IQ signals for signal to noise level improvements of up to 10 dB.

Another object is to provide a System And Method For Improved Transport and Analysis Of Digital Rf Signals In A Radio Network that enables more advanced value added processing, analysis, and signal treatment than otherwise possible via an architecture that reduces electrical power and processing load on power and space-constrained remote small cell antenna locations via centralized and/or cloud-based processing with substantially fewer power and space limitations, in turn enabling always more advanced RF analysis and treatment algorithms to be applied than that possible at the more power and space limited remote antenna sites.

Another object is to provide a System And Method For Improved Transport and Analysis Of Digital Rf Signals In A Radio Network that enables IQ symbol and RF analysis, classification, switching, and treatment on a per-end device and per RF energy source basis via the integrated RF signature pattern recognition, matching, classification, marking, and RF parameter-setting capabilities.

Another object is to provide a System And Method For Improved Transport and Analysis Of Digital Rf Signals In A Radio Network that enable flexible and varied RF signal treatment including though not limited to directed transmit power control.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an Overall Block Diagram of the present invention. This is the overall block diagram view of the improved digital RF signal transport and analysis system and method. It illustrates the relationship amongst the Main Elements.

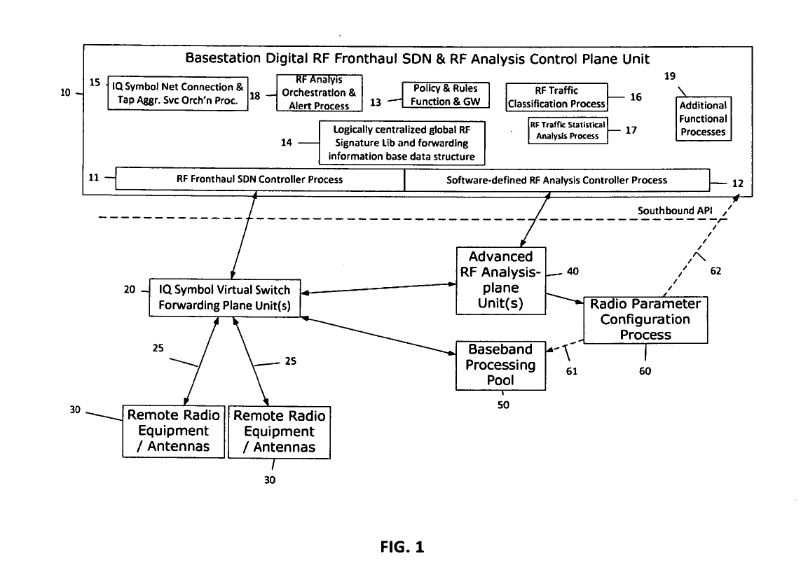

### DETAILED DESCRIPTION OF THE INVENTION

### A. Overview

Turning now descriptively to the drawings, in which similar reference characters denote similar elements throughout the several views, the figures illustrate a base station digital RF fronthaul software-defined network and RF analysis control plane unit, IQ symbol virtual switch forwarding plane unit(s), Remote radio equipment/antenna unit(s), RF analysis plane unit(s), baseband processing pool, radio parameter configuration process.

### B. Basestation Digital Rf Fronthaul Software-Defined Network and Rf Analysis Control Plane Unit

Remotely controls the IQ symbol virtual switch transport/forwarding plane units via configuration commands and forwarding command rulesets. It's internal controller processes are controlled by application processes (e.g.: network connection and tap aggregation orchestration, traffic classification, traffic statistical analysis, rf payload analysis orchestration and alert, other) that run on the control plane unit that generate the configuration commands and switch forwarding or instrument triggering rulesets for the controller processes to execute both local to the controller and remotely via the remote IQ symbol switch and RF analysis units.

10 stores and processes a global view of the forwarding plane topology and logically centralized global master copy of the integrated RF signature library and forwarding information base data structure 14, and forwards subsets of this global data structure as updates to the local rules data structures, 23 and 43, of the IQ symbol virtual switch forwarding plane unit(s) 20 and the RF analysis-plan unit(s) 40 respectively.

Remotely controls the IQ symbol virtual switch transport/forwarding plane units via configuration commands and forwarding command rulesets. It's internal controller processes are controlled by application processes (e.g.: network connection and tap aggregation orchestration, traffic classification, traffic statistical analysis, rf payload analysis orchestration and alert, other) that run on the control plane unit that generate the configuration commands and switch forwarding or instrument triggering rulesets for the controller processes to execute both local to the controller and remotely via the remote IQ symbol switch and RF analysis units.

10 stores and processes a global view of the forwarding plane topology and logically centralized global master copy of the integrated RF signature library and forwarding information base data structure 14, and forwards subsets of this global data structure as updates to the local rules data structures, 23 and 43, of the IQ symbol virtual switch forwarding plane unit(s) 20 and the RF analysis-plan unit(s) 40 respectively.

While the control plane unit is logically centralized, the implementation may alternatively be physically distributed for multiprocessing, multi-computing, and cloud based execution. This also then supports mesh, mobile, and swarm networking topologies and approaches.

The traffic classification process's classifications/labels, can alternatively be auto-generated from the RF spectrum analysis function and labels and membership may be either deterministic or probability based.

The logically centralized global integrated RF signature library and forwarding information base data structure is preferably implemented as, though not limited to, an associative array.

The software defined network and RF analysis control plane function is also applicable to non-data-communications environments such as remote sensing.

### C. Iq Symbol Virtual Switch Forwarding Plane Unit(s)

The at least one IQ symbol virtual switch forwarding plane unit is a distributed virtualized digital RF data forwarding unit remotely controlled by the digital RF fronthaul software-defined network control plane process of 10. It, 20, forwards from source(s) to sink(s) according to local forwarding rulesets received from 10 and stored in 20's local forwarding information base.

The at least one IQ symbol virtual switch forwarding plane unit is a distributed virtualized digital RF data forwarding unit remotely controlled by the digital RF fronthaul software-defined network control plane process of 10. It, 20, forwards from source(s) to sink(s) according to local forwarding rulesets received from 10 and stored in 20's local forwarding information base.

Alternatively, the forwarding plane units can provided preprocessing functions including but not limited to compression and FFT/iFFT before sending to the baseband pool.

The virtual switch interface can alternatively be applied to both virtual and physical hardware ports for integrated management of hybrid virtual and physical switching environments as well as direct integration to the CPRI transport (whether optical, electrical, or wireless).

The IQ symbol virtual switch forwarding function is also applicable to non-data-communications environments such as remote sensing.

### D. Remote Radio Equipment Unit(s)

The remote radio equipment/antennas unit (s) provide the RF transceiver and passive or active, single or multi-element antenna system capability of the radio access network.

The remote radio equipment/antennas unit (s) provide the RF transceiver and passive or active, single or multi-element antenna system capability of the radio access network.

Alternatively, the remote radio equipment units can provided preprocessing functions including but not limited to compression and encryption before sending to the IQ symbol virtual switch forwarding plane unit(s).

The remote radio equipment and antenna system function is also applicable to non-data-communications environments such as remote sensing.

### E. Rf Analysis-Plane Unit(s)

### Advanced Rf Analytics Pool

The at least one RF analysis plane unit is an instrument and analysis unit providing IQ symbol payload spectrum, vector, and deep signal analysis and treatment that is controlled by the digital RF fronthaul software-defined RF analysis control plane process of 10. It, 40, does this according to local config and triggering rulesets received from 10 and stored in 40's local configuration and analysis base subset of the global master copy residing in the logically centralized and integrated global RF signature library and forwarding information base data structure 14 of the central control plane unit 10.

The at least one RF analysis plane unit is an instrument and analysis unit providing IQ symbol payload spectrum, vector, and deep signal analysis and treatment that is controlled by the digital RF fronthaul software-defined RF analysis control plane process of 10. It, 40, does this according to local config and triggering rulesets received from 10 and stored in 40's local configuration and analysis base subset of the global master copy residing in the logically centralized and integrated global RF signature library and forwarding information base data structure 14 of the central control plane unit 10.

The RF analysis-plane function is also applicable to non-data-communications environments such as remote sensing.

### F. Baseband Processing Pool

The baseband processing pool provides the communications processing and path out to and back in from the higher level packet based core network. It may be implemented simply as remote traditional baseband processing pool, cloud-RAN baseband processing pool, or virtualized cloud-RAN baseband processing pool.

The baseband processing pool provides the communications processing and path out to and back in from the higher level packet based core network. It may be implemented simply as remote traditional baseband processing pool, cloud-RAN baseband processing pool, or virtualized cloud-RAN baseband processing pool.

The baseband processing pool can utilize traditional or software-defined radio techniques executing on any combination of communications digital signal processing resources including FPGA, hardware accelerator, DSP, GPU, CPU.

### G. Radio Parameter Configuration Process

The radio parameter configuration process may reside as part of or separate from the overall central control plane unit and sends RF parameter configuration commands to either or both the baseband pool and directly to the remote radio equipment/antenna unit(s).

The radio parameter configuration process may reside as part of or separate from the overall central control plane unit and sends RF parameter configuration commands to either or both the baseband pool and directly to the remote radio equipment/antenna unit(s).

The radio parameter configuration function is also applicable to non-data-communications environments such as remote sensing.

### H. Connections of Main Elements and Sub-Elements of Invention

The sub-elements are connected within each main element via a local or remoted interprocess communications.

The remote radio equipment will most often, though not exclusively, communicate to the IQ symbol virtual switch forwarding plane units via CPRI and OR standard radio interface protocols and supporting channels.

### I. Alternative Embodiments of Invention

The overall method and system is also applicable to non-data-communications environments such as remote sensing.

Each element can also be physically distributed from an execution architecture and data structure storage perspective.

All IQ symbol traffic can alternatively be compressed and/or encrypted and/or capsulated for efficiency, security, and privacy and chain of custody needs.

Fully mobile and geographically dynamically related antenna systems.

may alternatively be utilized. The fixed location basestation model noted here is only a special case of the more general moving base station case (as with, for example, evolutions of WiFi Direct and LTE-Direct capabilities).

### J. Operation of Preferred Embodiment

The uniqueness of this invention resides in both the internal operations and in the end results that are either better or newly enabled vs. Current state of the art.

Internal operational improvements include a high-performance/high-speed software implementation of the virtual switch 20 that can execute on commodity hardware if needed and is fast enough to enable high level software programmability via 10 and the applications 15, 16, 17, 18, 19, of the RF fronthaul network and RF analysis resources and functions. Also key is the extension of the more traditional “match/action” forwarding table data structures of packet switches and routers with RF signature data elements, 14.

Newly enabled or better end results include cross-domain control and flexible software programmability of RF transport/switching 20 with RF analysis 40. This integration relies greatly on the RF signature pattern recognition/pattern matching capability and RF signature data element extension of the match/action table data structure. This enables a global view, match, and action capability all the way down to the otherwise opaque radio energy processing layer, providing a globally correlated sense and coordinated response capability to telecommunications providers.

Advanced error vector magnitude analysis of the digital RF IQ symbols (sent from 20) by 40 allows characterization and of the analog I and Q errors and correction in either or both the digital domain (via 60 and 50) and the analog domain (via 60 and 30), with up to a 10 dB signal to noise ratio increase opportunity, providing both better coverage and capacity.

RF software defined network and analysis controller processes, 10 11 12, drive analysis and switching actions in 40 and 20 to slice (aka sub-streaming or diverting) subsets of RF IQ symbol traffic by frequency, amplitude, phase, code or any combination thereof to further downstream processing by the RF-Analysis Plane 20 or the BBU pool 50. For example, slicing (splitting out) IQ symbol traffic from a shared neutral host antenna systems by overall frequency better supports multiple operator and wholesale business and operations models.

The RF signature pattern recognition and classification capability (14, 16, 18, 42, 43, 44) allows multi-level classification, including in particular known/unknown and associated treatment.

Upon recognition of the RF signature of a known end device in 14, via 12, 14, 18, and 60 signal transmit power—and associated download speed—can be reduced or increased specifically to that known end device per local RF signature match/action rules sourced from RF SDN Controller's global M/A rule base 14 (which can alternatively in-turn be partially sourced from a carrier's external PCRF/Policy Charging and Rules Function Rule Base via 13). Further, transmit power can be reduced to zero for devices blacklisted for—for example—defective/out of conformance uplink transmit, security, theft, or non-payment reasons.

If the RF energy source is not recognized, it may either or both be passed through directly to the broadband processing pool 50 or sent to 10 for initial statistical classification 16 17 and optionally marked by 12 and 18 for further RF payload analysis by the RF analysis-plane unit 40. Example actions include adding the newly generated RF signature to RF signature library/base 14 as a known device, a noise source, or an interference source, with further actions via 60 including though not limited to reducing downlink transmit power to zero for the directional beam most closely targeted to the source, or marking source for external active treatment such as interference mitigation.

RF software defined network and analysis controller processes, 10 11 12, drive analysis and switching actions in 40 and 20 to subsets of RF IQ symbol traffic by frequency, amplitude, phase, code or any combination thereof to further downstream processing by the RF-Analysis Plane 20 or the BBU pool 50. Allocating those subsets to different execution units within 20 and/or within 50 better enables loadbalancing of processing resources within 20 and 50 as well as reducing the actual overall load presented to those units/pools.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by the examples given.

### INDEX OF ELEMENTS

10: Basestation Digital Rf Fronthaul Software-defined Network and Rf Analysis Control Plane Unit
11: Rf Fronthaul Software-defined Network Controller Process
12: Software-defined Rf Analysis Controller Process
13: Policy And Rules Function And Gateway
14: Logically Centralized Global Rf Signature Library And Forwarding Information Base Data Structure
15: Iq Symbol Network Connection and Tap Aggregation Service Orchestration Process
16: Rf Traffic Classification Process
17: Rf Traffic Statistical Analysis Process
18: Rf Analysis Orchestration and Alert Process
19: Additional/other Function Process
20: Iq Symbol Virtual Switch Forwarding Plane Unit(s)
21: Software-defined Network Control Plane Interface Function
22: Iq Symbol Switch Forwarding Function
23: Switch-local Forwarding Information Base Data Structure
24: Physical And Virtual Transport Interface Function
25: Transport Connectivity
26: Optional Iq Signal Preprocessing Function
30: Remote Radio Equipment Unit (s)
31: Analog-digital Iq Symbol Modem Function
32: Rf Transceiver(s)
33: Antenna(s)
34: Optional Iq Symbol Preprocessing Function
40: Rf Analysis-plane Unit(s) (advanced Rf Analytics Pool)
41: Software-defined Rf Analysis Control Plane Interface Function
42: Rf Analysis Plane Analysis Function
43: Analysis-plane-local Rf Signature Library Data Structure
44: Payload-based RI Traffic Classification Function
45: Physical And Virtual Transport Interface Function
50: Baseband Processing Pool
51: Interface To Radio Parameter Configuration Process
52: Interface To Iq Symbol Virtual Switch Forwarding Plane Unit (s)
60: Radio Parameter Configuration Process
61: Interface To Broad Band Processing Pool Units
62: Interface To Basestation Digital Rf Fronthaul Software-defined Network And Rf Analysis Control Plane Unit

I claim:

1. A method for improved transport and analysis of digital RF signals in a radio network, comprising the steps of:
(a) A high performance/high speed software implementation of an IQ symbol stream virtual switch that is fast enough to enable high level software programmability via an RF software defined network and analysis controller function is driven by the controller, and
(b) the integrated RF transport and RF analysis plane functions recognize and classify RF signature patterns, and
(c) upon recognition of the RF signature of a known end device, reduces or increases the associated signal transmit power per RF signature match/action rules sourced from the RF SDN Controller's global match/action rule base, the rules of which implement any given power control policy irrespective of a given communication or sensing technology or standard, and
(d) upon not recognizing the RF signature of a given device, all or a subset of its associated IQ symbol stream may either or both be passed through directly to the broadband processing pool or sent for classification and analysis and passive or active handling and treatment by the analysis and action response processing pool.

2. A system for improved transport and analysis of digital RF signals in a radio network, comprising the steps of:
(a) A high performance/high speed software implementation of an IQ symbol stream virtual switch that is fast enough to enable high level software programmability via an RF software defined network and analysis controller function is driven by the controller, and
(b) the integrated RF transport and RF analysis plane functions recognize and classify RF signature patterns, and
(c) upon recognition of the RF signature of a known end device, reduces or increases the associated signal transmit power per RF signature match/action rules sourced from the RF SDN Controller's global match/action rule base, the rules of which implement any given power control policy irrespective of a given communication or sensing technology or standard, and
(d) upon not recognizing the RF signature of a given device, all or a subset of its associated IQ symbol stream may either or both be passed through directly to the broadband processing pool or sent for classification and analysis and passive or active handling and treatment by the analysis and action response processing pool.
